(19) United States
(12) Patent Application Publication
(10) Pub. No.: US 2023/0401458 A1
(43) Pub. Date: Dec. 14, 2023

(54) MACHINE-LEARNED REDLINING CLASSIFICATION

(71) Applicant: LexCheck Inc., New York, NY (US)

(72) Inventors: Michael Ludwig Ross, Brooklyn, NY (US); Alexander Dylan Sugar, Brooklyn, NY (US); Gurinder Singh Sangha, New York, NY (US)

(21) Appl. No.: 17/835,191

(22) Filed: Jun. 8, 2022

(51) Int. Cl. G06N 5/02

(52) U.S. Cl. CPC G06N 5/022

(57) ABSTRACT

An artificial intelligence (AI) system classifies a document by a document type and determines redlining for the document based on the classified document type. The AI system may use machine learning to classify the document, where the AI system trains a machine-learned model using training documents of respective types. After determining the document type of a target document, the AI system compares the target document against one or more templates of the classified document type to determine edited or unedited portions of the target document. The AI system can modify an unedited portion of the target document using a predetermined edit associated with a template. The modified document target document may be displayed at a client device such that the edits (e.g., the modified unedited portion and existing edits in the target document) are visually distinct from one another.

This disclosure relates generally to artificial intelligence and in particular, to machine-learned redlining classification of documents.

### BACKGROUND

Redlining can be used during the negotiation of an agreement document. Redlining involves marking text in a document to indicate that there have been differences relative to another version of the document (e.g., additions, changes, rejections, approvals, deletions, etc.). Automated text comparison tools merely identify differences without additional information. For example, a comparison tool may attribute all changes in a document to one user regardless of whether the changes came from different sources. Furthermore, conventional text comparison tools require a user to specify two documents to compare. If the user wishes to compare against multiple documents, the user is asked to repeat this process for different pairs of documents. If the user wishes to view the differences between one document and the multiple documents, the user is required to manually aggregate all differences into one document. Furthermore, it is not guaranteed that the aggregated differences are visually distinct from one another (e.g., the changes among documents that are combined into one document may all be colored in red font using strikethrough or underlining for deletion of addition of text, respectively). In addition to consuming the user's time to manually perform comparisons, aggregate changes between documents, and ensure that the changes are appropriately visually distinct from one another, conventional text comparison tools can consume a large amount of processing and memory resources to perform each pairwise comparison and store the results. For example, manually repeating a pairwise comparison between a target licensing document and dozens of different licensing documents from different law firms is burdensome on a user and a computing device. A conventional text comparison tool may expend a large amount of processing and memory resources in this manual process. Accordingly, conventional text comparison tools lack functionality for comparison with multiple documents and consume a large amount of processing and memory resources when attempting such a comparison through existing, insufficient means.

### SUMMARY

Within the realm of redlining for negotiating an agreement, conventional text comparison tools are even further deficient in their ability to distinguish between different types of agreements. While a conventional text comparison tool must rely on a user to manually specify which agreement document to reference for comparison, an artificial intelligence (AI) system described herein determines a type of agreement document that a user is requesting to redline and uses that classification to redline the document against other documents of that agreement type. Thus, a user may specify a target document they wish to redline and then receive, from the AI system, a redlined version of the target document showing editing differences that include where the edits are sourced from and are shown as visually distinct from one another. For example, a user provides a stock purchase agreement to the AI system, which then determines that the document is a stock purchase agreement and compares the user's agreement to stock purchase agreements from various sources (e.g., publicly available records of past agreements provided by a government entity). The AI system then displays a redlined version of the user's stock purchase agreement with different, for example, colored fonts, highlights, text borders, etc., to distinguish edits from one source from another's.

In one embodiment, the AI system accesses a set of training documents corresponding to document templates of respective document types. The AI system trains a machine-learned model using the set of training documents. The machine-learned model is configured to classify a document as having a particular type of the respective document types. The AI system applies the machine-learned model to a target document to classify a document type of the target document. The AI system then compares the target document against a first template having the same document type as the target document and from the comparison, identifies edited and unedited portions of the target document. The AI system may modify the unedited portion of the target document using a predetermined edit associated with the first template or a second template (e.g., a standard template of another firm's version of the agreement document or a response template of the agreement document that includes predetermined edits for further negotiation). The AI system displays the target document to a viewing entity (e.g., via a client device of a user who requested redlining) such that the modified portion is visually distinct from the edited portion.

### BRIEF DESCRIPTION OF THE DRAWINGS

FIG. 1 is a block diagram of a system environment 100 in which an artificial intelligence (AI) system operates, in accordance with one embodiment.

FIG. 2 is a block diagram of the AI system of FIG. 1, in accordance with at least one embodiment.

FIG. 3 shows a block diagram of the AI system of FIG. 1 providing a redlined document to a client device, in accordance with one embodiment.

FIG. 4 depicts example documents used during and as a result of redlining a target document, in accordance with one embodiment.

FIG. 5 depicts example documents used during and as a result of redlining a target document including various edits from counterparties, in accordance with one embodiment.

FIG. 6 is a flowchart illustrating a process for redlining a target document, in accordance with one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

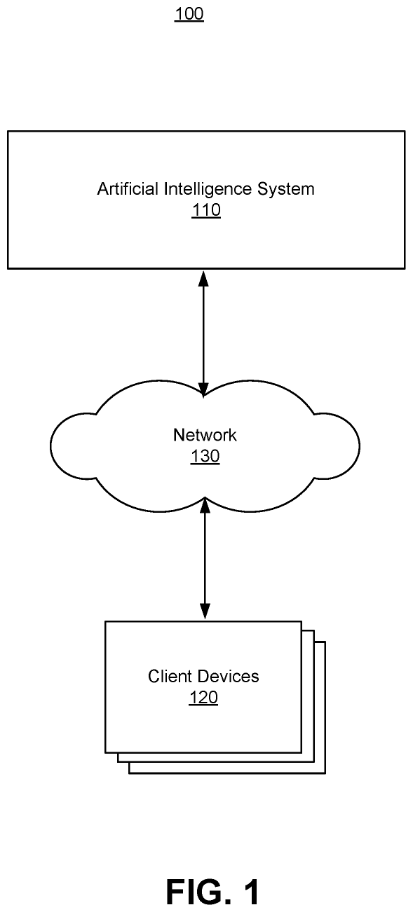

FIG. 1 is a block diagram of a system environment 100 in which an artificial intelligence system 110 operates, in accordance with one embodiment. The system environment 100 shown by FIG. 1 includes the artificial intelligence system 110, one or more client devices 120, and a network 130. The system environment 100 may have alternative configurations than shown in FIG. 1, including for example different, fewer, or additional components. For example, the system environment 100 may include a remote database separate from the artificial intelligence system 110 in which various templates for redlining comparison can be stored for access by the artificial intelligence system 110. A template may be a previously received, edited, or transmitted document used for a negotiation. A template may include one or more edits or may be unedited (e.g., an initial version of an agreement).

The artificial intelligence (AI) system 110 is a computer-based system utilized for AI powered redlining of documents (e.g., text documents). The text documents can be provided to the AI system 110 by the one or more client devices 120 or accessed at the AI system 110 by the client devices 120 via the network 130. A redlining task is a computing operation for redlining a target document. For example, multiple parties use respective client devices 120 to edit a target document using the AI system 110 during a negotiation. As referred to herein, a target document is a document that a user provides to the AI system 110 for redlining. The AI system 110 may track the edits that each of the parties make to the target document. The tracked edits may be relative to previous versions of the target document, relative to edits made by one or more particular parties, any suitable classification of edits, or a combination thereof. The tracked edits may include grammatical edits, changes characterizing scope of the agreement (e.g., changes to the terms), structural edits (e.g., the order of sections within the agreement), formatting edits, any suitable edit to an document subject to negotiation, or a combination thereof. The AI system 110 can perform multiple redlining tasks in parallel.

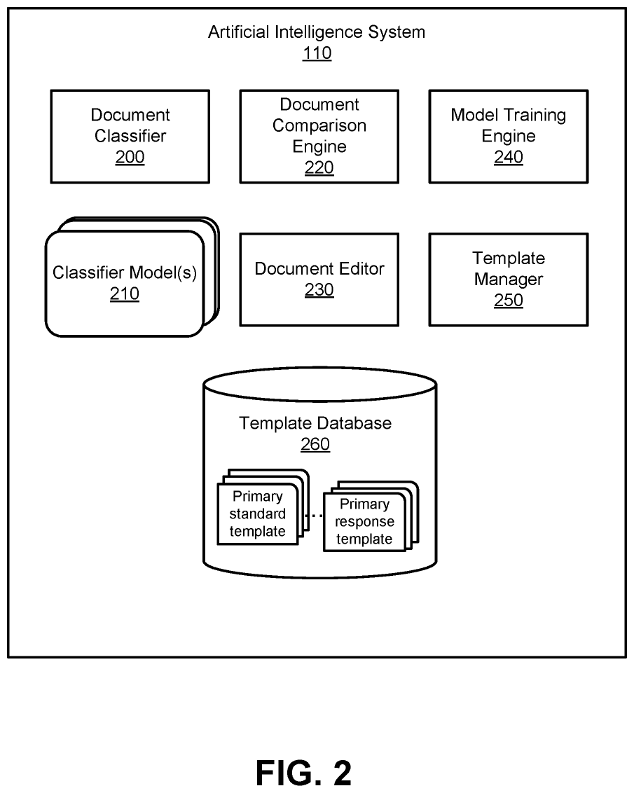

The computer-based system of the AI system 110 can include memory for storing data (e.g., templates for comparing a target document against for redlining purposes) and one or more processors that execute software modules for performing machine-learned classification of documents, document redlining, and display of the visually distinct edits made by one or more parties resulting from the redlining. The AI system 110 may train and apply a machine-learned model for classifying target documents into various document types. A document type characterizes a purpose for the document or a context in which the document is used. Examples of document types may include contracts, grants, terms of service, transfer agreements, employment agreements, non-disclosure agreements, sales agreements, franchise agreements, inbound agreements, licenses, indemnity agreements, order forms, property lease agreements, requests for proposals, statements of work, any suitable business agreement, or combination thereof. The AI system 110 may compare a target document to other documents of its type. The AI system 110 may use templates for this comparison, and select one or more templates to compare against the target document to generate a redlined version of the target document for display at a user's client device 120. Functions of the AI system are further described in the description of FIG. 2.

The network 130 may serve to communicatively couple the AI system 110 and the one or more client device 120. In some embodiments, the network 130 includes any combination of local area and/or wide area networks, using wired and/or wireless communication systems. The network 130 may use standard communications technologies and/or protocols. For example, the network 130 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 110 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network may be represented using any suitable format, such as hypertext markup language (HTML) or extensible markup language (XML). In some embodiments, all or some of the communication links of the network 130 may be encrypted using any suitable technique or techniques.

### Artificial Intelligence System

FIG. 2 is a block diagram of the AI system 110 of FIG. 1, in accordance with at least one embodiment. The AI system 110 may include one or more databases such as a template database 260. The AI system 110 may include software modules such as a document classifier 200, one or more classifier models 210, a document comparison engine 220, a document editor 230, a model training engine 240, and a template manager 250. The AI system 110 may have alternative configurations than shown in FIG. 2, including for example different, fewer, or additional components. For example, although not depicted, the AI system 110 may include wireless communications circuitry for receiving target documents and providing redlined target documents to the client devices 120. As another example, the AI system 110 may include natural language processing engines for comparing text between a target document and stored templates (e.g., to determine and compare meanings or sentiment represented by text).

The document classifier 200 classifies a document according to a document type. The document classifier 200 can determine a document type of a document using a machine-learned model. For example, a machine-learned model of the one or more classifier 210 may be applied to determine the document type of a document. The document classifier 200 may categorize a document by its document type. For example, the document classifier 200 may label or tag the document according to the type as output by a classifier model 210. The AI system 110 may use the document classifier 200 before determining redlining of a target document in order to determine one or more templates having the same document type as the target document. By comparing templates of the same document type as the target document, the AI system 110 increases the accuracy of the redlining (e.g., as determined by the document comparison engine 220).

The AI system 110 maintains one or more classifier models 210 for processing and classifying a document as a particular document type. The classifier models 210 may include machine-learned models, statistical models, or any suitable predictive algorithm for determining a likely document type of a document. Additionally, the classifier models 210 may include natural language processing models that are used to determine intent, context, or sentiment within text. One or more of the classifier models 210 may be used to preprocess text in a target document. Preprocessing may include analysis of words within sentences, removing syncategorematic words (e.g., articles, connectives, prepositions, quantifiers), or remove punctuation. One or more of the classifier models 210 may be used to generate feature vectors or embeddings from the preprocessed text. A classifier model 210 may generate a vector space of words based on their meaning (e.g., word2vec modeling). The classifier model 210 may place feature vectors representative of respective, related words closer together in the vector space. A classifier model 210 may be a machine-learned model that receives, as input, feature vectors representative of text within a document and output a document type of the document. Training of the machine-learned model is discussed in more detail with respect to the model training engine 240.

Machine-learned models used by the AI system 110 may use various machine learning techniques such as linear support vector machine (linear SVM), boosting for other algorithms (e.g., AdaBoost), neural networks, logistic regression, naïve Bayes, memory-based learning, random forests, bagged trees, decision trees, boosted trees, boosted stumps, a supervised or unsupervised learning algorithm, or any suitable combination thereof. These models can be any suitable machine learning model including neural networks for either regression or classification, random forest classifiers or regression models, logistic regression for classification, or linear regression.

The document comparison engine 220 determines redlining for a document against one or more documents. The document comparison engine 220 may compare a target document to one or more other documents to determine edited or unedited portions of the target document. The document comparison engine 220 may identify the one or more other documents for comparison. The document comparison engine 220 may determine edited or unedited portions of the target document. The document comparison engine 220 may map the edited or unedited portions of the target document to respective portions of the one or more other documents against which the target document was compared. That is, the document comparison engine 220 may compare the target document to another document and map an unedited portion of the target document to an unedited portion of the other document (e.g., matching string(s) of text). Similarly, the document comparison engine 220 may compare the target document to another document and map an edited portion of the target document to an edited portion of the other document.

The document comparison engine 220 can identify one or more other documents for comparison. In some embodiments, the document comparison engine 220 identifies templates for comparison to a target document. The document comparison engine 220 may access the template database 260 to determine one or more templates to compare against a target document. The document comparison engine 220 may use the document type of the target document (e.g., as determined by the document classifier 200) to determine which template(s) of the template database 260 to use for comparison. For example, the document comparison engine 220 may receive from the document classifier 200 that the target document's type is a voting agreement for shareholders and the document comparison engine 220 may query the template database 260 for one or more templates having the voting agreement document type. The document comparison engine 220 may then use the voting agreement template(s) to compare against the target document for redlining made as the target voting agreement document was exchanged between counter parties.

In some embodiments, the document comparison engine 220 identifies a template for comparison against the target document according to a user specification of a particular template or a default template. For example, the document comparison engine 220 may cause a graphical user interface (GUI) to be displayed at a client device 120 prompting the user to select one of the templates of all templates available in the template database 260 or of all templates of the target document's type available in the template database 260. The document comparison engine 220 may recommend a template for the user to select based on a number of times the recommended template has been used for redlining (e.g., recommending the most frequently used template of the target document's type) or based on an accuracy of the redlining produced by the recommended template (e.g., the document comparison engine 220 has received the highest rating of positive feedback from redlining produced using the recommended template). The document comparison engine 220 may automatically determine respective default templates to use for different document types or receive user selections of the default templates. The document comparison engine 220 can, for example, set a recommended template as a default template (e.g., based on frequency of use or user feedback of the template's redlining accuracy).

The document comparison engine 220 may determine edited or unedited portions of a document. In some embodiments, the document comparison engine 220 may use string comparison or a comparison of feature vectors extracted from the documents to determine matching edited or unedited portions of text between two documents. For example, the document comparison engine 220 determines that a portion of text in a target document has been unedited because the same string of text is found in a template that is compared against the target document. In some embodiments, the document comparison engine 220 uses machine learning to determine edited or unedited portions of text between two documents. For example, the AI system 110 may include, although not depicted, one or more machine-learned models trained using training documents that include one or more edits. The training documents may be one or more sets of edited versions of a document (e.g., version histories of seven different types of vendor agreements). The AI system 110 may train one or more machine-learned models to identify edits across the versions of a document, which can include the addition, deletion, or movement of text. The training documents may be used to create training data that is labeled according to the presence or absence of edited data between two documents (e.g., successive versions of a document). Artificial intelligence for redlining of text documents is further described in U.S. patent application Ser. No. 17/468,276, filed on Sep. 7, 2021, which is incorporated by reference for all purposes.

The document comparison engine 220 may identify various types of edits within an edited portion of a target document. The types of edits may include a first set of edits that are similar to edits made within training documents and a second set of edits that are not similar to the edits made within training documents. The document comparison engine 220 may use a threshold similarity comparison when determining whether edits are similar. For example, the document comparison engine 220 may determine respective vector representations of the edited “Voting Provisions” section of a target voting agreement document and a voting agreement template used as a training document. The document comparison engine 220 may use a vector comparison algorithm (e.g., cosine similarity) to determine a quantified degree of similarity between the corresponding edited sections of two documents. The document comparison engine 220 may then compare the degree of similarity to a threshold similarity (e.g., comparing the result of the cosine similarity output to a threshold of 0.8). While the prior example references the comparison of edited portions of text, a similar comparison may be applied for determining the similarity of unedited portions of text. The document comparison engine 220 may tag or label the edited portions of text as being one of the first or second set of edits.

The document editor 230 modifies a target document using a predetermined edit. The predetermined edit may serve as an edit by one party to be presented to another party for consideration. The predetermined edit may be mapped to an edit to a document. For example, party A receives an edit to a vendor contract from party B specifying a set of equipment requested, and the AI system 110 maintains a template of a vendor contract document type that includes an edit adding a set of equipment and a corresponding predetermined edit specifying the duration with which the set of equipment will be loaned to party B (e.g., party A may present a redlined version of the vendor contract back to party B with the loan duration).

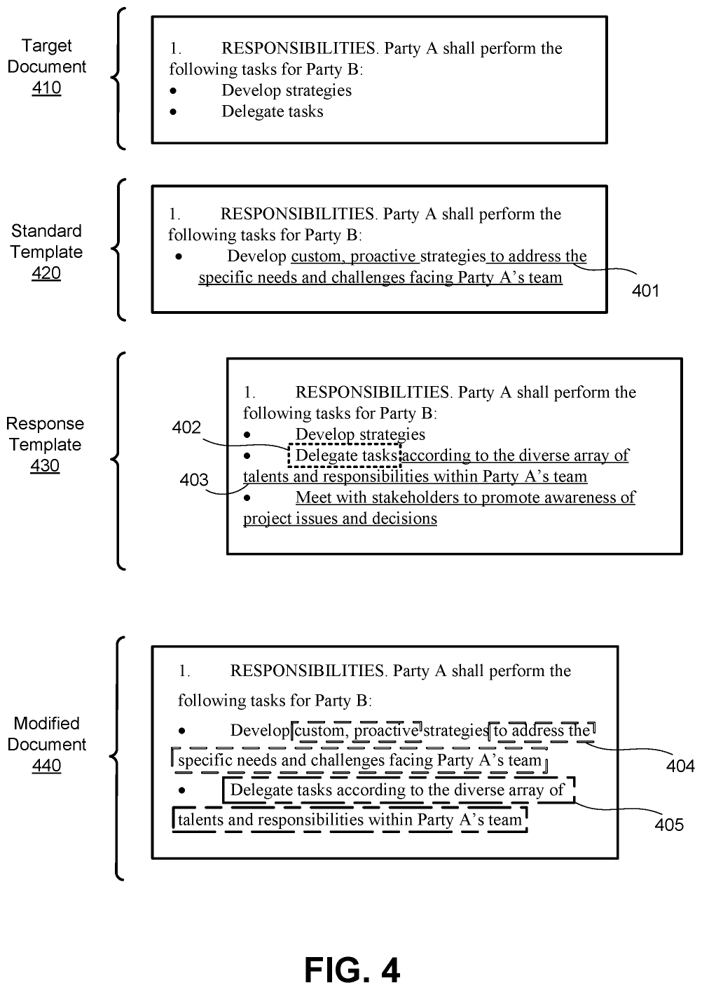

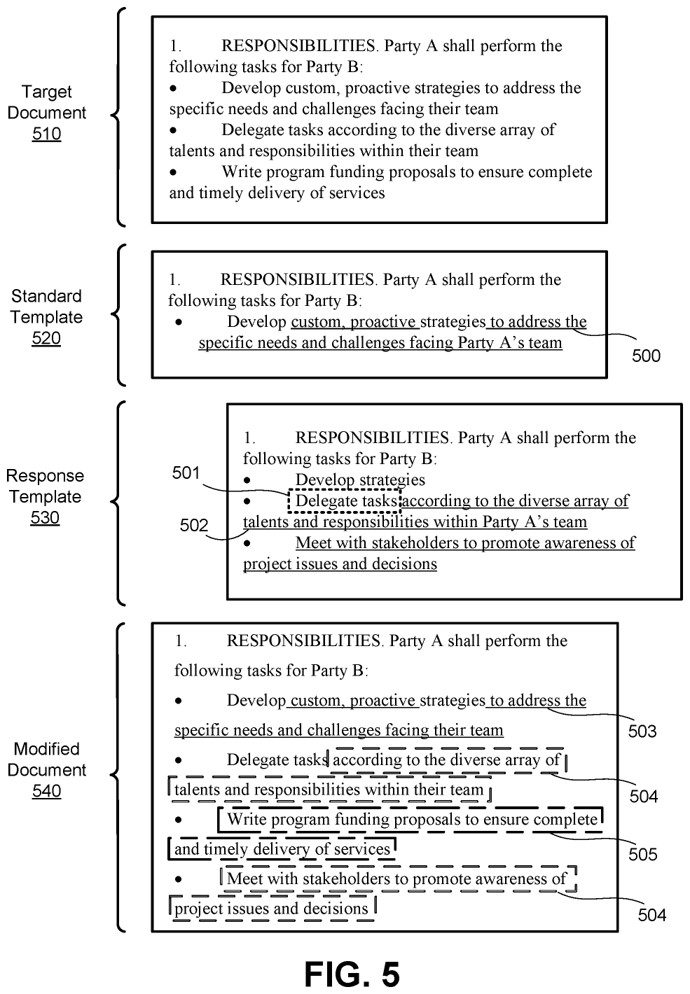

The document editor 230 may determine which portions of a target document to modify based on identified edited or unedited portions of the document, which can correspond to respective predetermined edits. The document editor 230 may receive, from the document comparison engine 220, a target document that has been compared against one or more templates to determine portions of the target document that are unedited or edited. Furthermore, the edited portions of the target document may also be tagged (e.g., by the document comparison engine 220) based on whether they include a first set of edits similar to a template (or a training document) or a second set of edits that were not similar (e.g., not found in prior templates or training documents). The document editor 230 may use a template to determine a predetermined edit to apply to a target document. A template may include a predetermined edit that is mapped, by the AI system 110, to an edit within the template. The document editor 230 may use an edit of the first set of edits to query a template for a corresponding predetermined edit. The document editor 230 may then replace modify the target document according to the predetermined edit (e.g., adding, removing, or replacing a string of text within the target document). The document editor 230 may also label the edits with which it modifies a target document using the source of the edit. For example, the document editor 230 may label a first edit as being attributed to a template of a first source and label a second edit as being attributed to a template used by a second source. Examples of edits and predetermined edits are described with regard to FIGS. 4 and 5.

The model training engine 240 trains machine-learned models of the AI system 110. The model training engine 240 may train the one or more of the classifier models 210. For example, the model training engine 240 uses training documents that include edits made by one or more entities (e.g., parties within a negotiation) to train a classifier model 210 to determine a document type of a target document. The model training engine 240 may generate training data that includes labeled feature vectors representative of the text of previously redlined documents, where the labels indicate a document type of the redlined document.

In some embodiments, the model training engine 240 trains a machine learning model in multiple stages. In a first stage, the model training engine 240 may use generalized data collected across various documents of a particular document type to train the machine learning model. The generalized data may be edits to the documents labeled with the particular document type. For example, various intellectual property licensing agreements used by various entities (e.g., educational institutions, manufacturers, laboratories, etc.) are collected for training a classifier model 210 during the first stage, where training data extracted from these licensing agreements are labeled to indicate the licensing agreement document type. The model training engine 240 then creates a first training set based on the labeled generalized data. The model training engine 240 trains a machine-learned model, using the first training set, to determine whether a document is of a particular type (e.g., an intellectual property licensing agreement). That is, the machine learning model is configured to receive, as an input, data extracted from a target document and output a classification of whether the target document is a particular type. The document classifier 200 may use other models of the classifier models 210 to extract data for input into the machine-learned model.

In a second stage of training, the model training engine 240 may tailor the document type classification according to a particular condition (e.g., based on documents redlined by a particular entity, documents redlined by entities in a specific field of operation, documents redlined among specific entities, etc.). The model training engine 240 creates a second training set based on documents associated with the particular condition and labels identifying data (e.g., edits) extracted from the documents as belonging to a document of a particular type. For example, during the second stage of training, a particular entity retrains the machine-learned model using intellectual property licensing agreements that the particular entity has previously negotiated (in contrast to licensing agreements that a general population of entities have negotiated) in order to tailor the document classification to licensing agreements that are used by the particular entity. Furthermore, the second training set may be created based on user feedback associated with successful classification of documents into a particular document type. For example, a user provides feedback that a machine-learned model correctly classified a target document as an intellectual property licensing agreement. In some embodiments, the first training set used to train that model may also be included in the second training set to further strengthen a relationship or association between data and document type classification during the second stage of training. The model training engine 240 then re-trains the machine-learned model using the second training set such that the machine-learned model is customized to a particular condition in which documents are to be classified.

The template manager 250 modifies templates and maintains relationships between templates. In some embodiments, the template manager 250 manages various document type templates. Within each document type, the template manager 250 manages a standard template and a response template. A standard template can be a template used as a basis for a target document (e.g., a first version of a target document). A response template may be a template containing edits made to a standard template with the intention of responding to a counterparty that has presented the standard template during a negotiation. For example, an entity seeking to present a non-disclosure agreement to a third-party may seek the standard template for use while the third-party receiving the standard template may seek the response template for modifying the standard template with proposed edits to the terms of the non-disclosure agreement.

The template manager 250 may map standard templates to response templates. In some embodiments, the template manager 250 manages multiple variants of standard and response templates. For example, the template manager 250 manages different licensing agreements corresponding to different vendors with which an entity operates, where each licensing agreement has a standard template and one or more corresponding response templates. The template manager 250 can designate a primary standard template and a primary response template. The primary standard and response templates may be used by default as the template(s) against which the document comparison engine 220 compares a target document. The template manager 250 may automatically determine a new primary template or receive a user instruction to assign a different template as a primary template. As referred to herein, the term “primary template” may refer to one or both of a primary standard template or a primary response template. The template manager 250 may automatically determine a new primary template based on an operational statistical (e.g., a frequency of use of a particular template for redlining). For example, the template manager 250 can set the primary standard template as the standard template that is most frequency used.

The template manager 250 may track changes to a primary template. For example, the template manager 250 may track edits made to copies of the primary standard template. The AI system 110 may maintain a storage of the copies made by the client devices 120 of the primary standard template and determine edits made to the copies (e.g., using the document comparison engine 220). For example, in response to determining that a particular edit has been made over a threshold number of times (e.g., at least ten times) to copies of the primary standard template, the template manager 250 may modify the primary standard template to incorporate the particular edit in the original document.

In some embodiments, the template manager 250 may create new templates as target documents are received by the AI system 110 for redlining. The template manager 250 may receive the document type of the target document, as determined by the document classifier 200, and store the target document as a template within the template database 260 categorized by the document type. In some embodiments, the template manager 250 may determine whether a new template is a standard template or a response template based on a comparison of the new template is more similar to a standard template or to a response template. For example, the template manager 250 leverages the document comparison engine 220 to determine a degree of similarity (e.g., by extracting features of the documents and applying a vector similarity algorithm) between a standard template and a degree of similarity between a response template. The template manager 250 may compare the degrees of similarity and assign the new template to either the standard or response template based on the comparison.

The template database 260 stores templates for use in redlining documents by the AI system 110. The template database 260 may categorize templates according to document type, where templates of a particular type are categorized or tagged to be queried based on their document type. The template database 260 may store primary templates of each document type. The template database 260 may store mappings of standard templates to response templates. The template database 260 may additionally or alternatively store training documents for the model training engine 240 to train a machine-learned model of the AI system 110. The templates stored within the template database 260 may function as both templates for the document comparison engine 220 to determine redlining and as training documents for the model training engine 240. Although depicted as a component of the AI system 110, the template database 260 may be a database remote from the AI system 110 but accessible over the network 130.

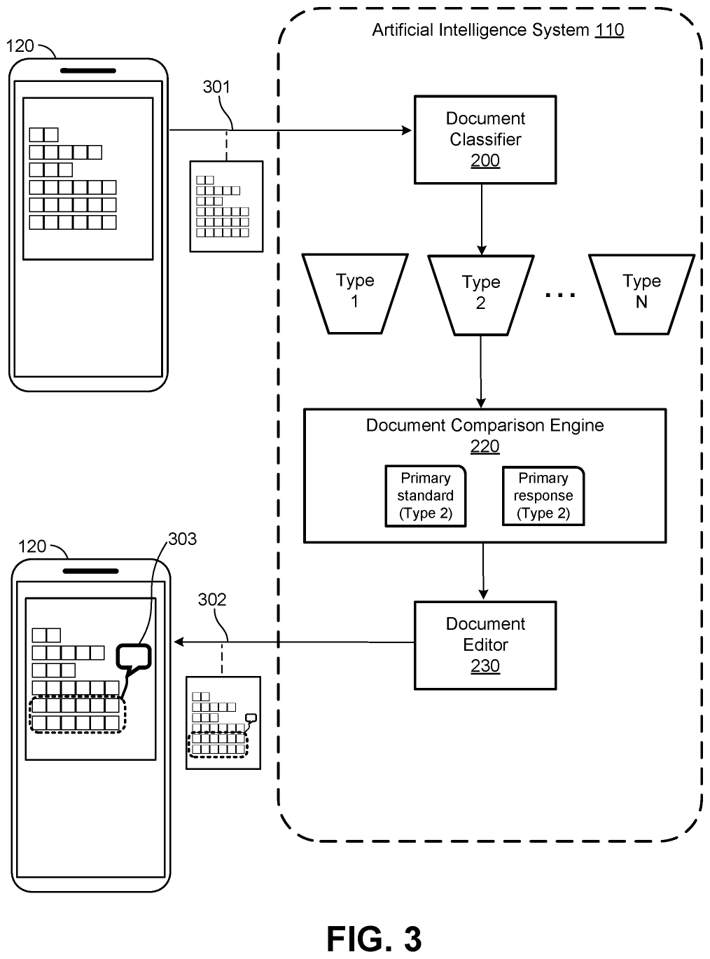

FIG. 3 shows a block diagram of the AI system 110 of FIG. 1 providing a redlined document to a client device, in accordance with one embodiment. The client device 120 provides and receives documents to the AI system 110 over a network (e.g., the network 13). The AI system 110 applies the document classifier 200, document comparison engine 220, and the document editor 230 to redline a document based on a document type. In particular, the AI system 110 receives a target document 301 from the client device 120. The text of target document 301 is represented for clarity through a series of boxes. The client device 120 receives a redlined version 302 of the target document 301, where the redlined version 302 is depicted as having a dashed circle around some portions of the text (e.g., an edited portion of the text that is similar to an edit in a template or an edit that is different from edits in a template) to distinguish those portions against other portions of the target document 301 (e.g., unedited portions of the document). While one type of visual distinction is depicted for clarity, there may be other types of visual distinctions in place of the dashed circle shown or additional visual distinctions to identify other types of edits different from the edits encircled in a dashed line. Although FIG. 3 has provided a high level view of a redlined document for clarity, examples of target documents, templates, and redlined documents are shown in further detail in FIGS. 4 and 5.

The redlining process shown in FIG. 3 may begin with the AI system 110 receiving the target document 301 from the client device 120. For example, the target document 301 may be an agreement document such as an employment agreement negotiated between two parties (e.g., an employer and a prospective employee). The AI system 110 classifies the target document 301 according to a document type using the document classifier 200. The document classifier 200 may classify the target document 301 into one of N types of documents. The document classifier 200 can apply a machine-learned model to the target document 301 to determine a document type, where the AI system 110 trained the machine-learned model using previous documents of the particular type. Following the previous example, the document classifier 200 may classify the target document 301 as an employment agreement type, depicted as a second type of document among the N types of documents.

The document comparison engine 220 uses the classified document type to identify one or more templates with which to compare the target document 301 against. As depicted, the document comparison engine 220 uses a primary standard template and a primary response template of the second document type to compare against the target document 301. Following the previous example, the document comparison engine 220 identifies a primary standard template for an employment agreement and a corresponding primary response template having an employment agreement type. The primary standard template may be an initial version of an employment agreement and the primary response template may be an edited version of the employment agreement. The AI system 110 may automatically determine which templates of the employment agreement type are the primary templates based information related to the user of the client device 120. For example, the user of the client device 120 may be in the human resources department of a corporation in the aerospace industry. Information such as the user's job title (e.g., manager), department (e.g., human resources), corporation industry (e.g., aerospace), any other suitable information describing the entity or party receiving the document under negotiation, or combination thereof may be referred to as profile information. The document comparison engine 220 may request or query for profile information about the user of client device 120 (e.g., from a database of profile information maintained locally at the AI system 110 or a third-party managing the profile information for the entity) before selecting the primary template(s) used to compare against the target document 301. For example, the document comparison engine 220 selects a particular standard template as the primary standard template based on its frequency of use by human resource departments of aerospace entities.

The document comparison engine 220 compares the target document 301 against one or more of the primary templates. In some embodiments, the document comparison engine 220 may perform a direct comparison of text strings from the target document 301 against text strings from a template to determine which portions of the target document 301 have been edited relative to the template. The template may include edited and unedited text. In a first example of a comparison, a string that is found in the target document that matches a string in the template's unedited text may be considered unedited text of the target document 301. In a second example of a comparison, a string that is in the target document 301 and matches a string in the edited portion of the template may be considered in a first set of edits of the target document 301 as matching an edit in the template. In a third example of a comparison, a string that is in the target document 301 but not in the template may be considered in a second set of edits of the target document 301 as an edit that was not previously included within the template.

In some embodiments, the document comparison engine 220 compares the target document 301 against one or more primary templates using a machine-learned model. Although not depicted in FIG. 2, the AI system 110 may include one or more machine-learned models for determining likely areas of the target document 301 that have been edited. A machine-learned model may be trained using one or more training documents including edits by one or more entities. The training documents may include edited versions of a document of the same type as the target document 301. For example, the training documents include edited versions of an employment agreement that has been negotiated over various rounds among parties. The machine-learned models may receive, as input, two or more documents and output differences between the documents (e.g., edits between the documents).

The document comparison engine 220 provides the identified edited or unedited portions of the target document 301 to the document editor 230 to edit the document based on the identified edited or unedited portions. The document editor 230 may access one or more of the primary standard template or the primary response template to determine which predetermined edits correspond to the edited or unedited portions of the target document 301. A given template may include predetermined edits mapped to respective edited portions of the template. For example, a response template of an employment agreement may include an edit outlining additional responsibilities of a party and a corresponding predetermined edit may refine those additional responsibilities. Examples of predetermined edits are depicted in FIGS. 4 and 5. In some embodiments, the document editor 230 may iterate through unedited or edited portions of the target document 301 and implement, responsive to the presence of predetermined edits in a template, corresponding predetermined edits to the iterated unedited or edited portions.

After editing the target document 301, the document editor 230 creates a redlined version 302 of the target document 301. The redlined version 302 includes modifications to the target document 301 that causes portions of the target document 301 to be visually distinct from one another. For example, the redlined version 302 of an employment agreement includes different color of fonts for unedited text, edited text that matches a template, and edited text that does not match a template. In this way, the AI system 110 can produce a three-way redlined document. In some embodiments, a template may be annotated with user-provided comments (e.g., comments explaining why an edit was made) and the document editor 230 may annotate the redlined version 302 with comments from the template. For example, the comment 303 may be included in the primary standard template used by the document comparison engine 220 to identify an edit or corresponding predetermined edit, where the comment annotates the edit or corresponding predetermined edit. The document editor 230 may annotate the target document 301 with the comment 303 in addition to visually distinguishing the edit or corresponding predetermined edit from other portions of the document.

FIG. 4 depicts example documents used during and as a result of redlining a target document, in accordance with one embodiment. Four types of documents are shown: a target document 410, a standard template 420, a response template 430, and a modified document 440. A modified document may also be referred to herein as a “redlined document.” The documents 410-440 are of the same document type (e.g., employment agreement). For clarity, only portions of a sample agreement document are shown in FIG. 4, but the portions are referred to be the document from which they are extracted. The target document 410 may be an initial draft by Party A of an employment agreement presented by Party A to Party B. The standard template 420 may be a version of an initial draft of an employment that includes an edit 401 made by Party B. The response template 430 may be a version of the standard template 420 that includes one or more edits (e.g., an edit 402 including “delegate tasks”) and corresponding predetermined edits (e.g., a predetermined edit 403 further describing the task delegation of edit 402 and an additional responsibility by Party A). The modified document 440 is a redlined version of the target document 410 that is compared against both the standard template 420 and the response template 430. In some embodiments, the AI system 110 may compare to only one of the standard template 420 or the response template 430 (e.g., in response to a user selection specifying only one of the templates for redlining comparison).

In one example context in which the target document 410, the standard template 420, and the response template 430 are used to produce the modified document 440, Party A is entering an employment agreement with Party B, the employer. Party A presents the target document 410 to Party B. Party B, using a client device (e.g., the client device 120), provides the target document 410 to the AI system 110 for redlining. For example, Party B may use the AI system 110 to seek recommendations for additional clauses of the employment contract. The document classifier 200 may use a classifier model 210 to determine that the target document 410 is of the employment agreement type. The document comparison engine 220 may display a GUI on the client device of Party B prompting the user to select the employment agreement type templates against which the target document 410 is to be compared. Alternatively or additionally, the document comparison engine 220 may use default templates or automatically determine which template(s) to use based on a level of similarity between the target document 410 and one of the templates.

Following the previous example context, the document comparison engine 220 may identify edits that are in templates but not present in the target document 410. As shown in FIG. 4, the document comparison engine 220 may identify edit 401 as belonging to the standard template 420 but not in the target document 410. In response, the document editor 230 may include the edit 401 within the modified document 440 in a visually distinct formatting to designate to Party B that the edit was not originally present in the target document 410 but was present in a training document (the standard template 420 may be used to train a classifier model). For an unedited portion 402 and the predetermined edit 403 that the response template 430 has mapped to the unedited portion 402, the document comparison engine 220 may identify that the unedited portion 402 matches an unedited portion of the target document 410. In response, the document editor 230 may modify the target document 410 to include the predetermined edit 403.

The resulting modified document 440 includes edit 401 that is made visually distinct from other edits using a formatting 404, which is depicted as a box having hollow, dashed lines. The modified document 440 further includes predetermined edit 403 that is made visually distinct from other edits using a formatting 405, which is depicted as a box having filled, dashed lines. The AI system 110 sends the modified document 440 to the client device of Party B such that the user may review edits to the target document that are not yet in the target document 410 but may be included before sending back to Party A for further negotiation. As the user reviews the edits, the visually distinct formatting for respective edit sources enables the user to identify the origin of the redlining (e.g., edit 404 being from a template edited by Party B themselves or the predetermined edit 405 being a corresponding edit in response that was provided by Party B themselves).

FIG. 5 depicts example documents used during and as a result of redlining a target document including various edits from counterparties, in accordance with one embodiment. Similar to the example documents in FIG. 4, FIG. 5 depicts a target document 510, a standard template 520, a response template 530, and a modified document 540. The documents 510-540 are of the same document type (e.g., employment agreement). For clarity, only portions of a sample agreement document are shown in FIG. 5, but the portions are referred to be the document from which they are extracted. The target document 510 includes additional edits from counterparties that the target document 410 did not have. The modified document 540 is a redlined version of the target document 510 that is compared against both the standard template 520 and the response template 530. The modified document 540 includes visually distinct formatting to represent various counterparty edits already included within the target document 510. These edits may include edits incorporated from templates, predetermined edits (e.g., edits made in response to an existing or prospective counterparty's edit) incorporated from templates, edits not included in a template, or a combination thereof.

In one example context in which the target document 510, the standard template 520, and the response template 530 are used to produce the modified document 540, Party A is negotiating an employment agreement with Party B, the employer. Party A presents the target document 510 to Party B after previous rounds of editing the employment agreement (e.g., starting from an initial draft appearing similar to the target document 410). Party B, using a client device (e.g., the client device 120), provides the target document 510 to the AI system 110 for redlining. For example, Party B may use the AI system 110 to identify existing edits made by both parties and seek recommended edits for providing the employment agreement back to Party A for further negotiation. The document classifier 200 may use a classifier model 210 to determine that the target document 510 is of the employment agreement type. The document comparison engine 220 may then compare the target document 510 to templates of the employment agreement type (e.g., the standard template 520 and the response template 530).

Following the previous example, the document comparison engine 220 may identify that the edit 500 in the standard template 520 is present within the target document 510 and in response, the document editor 230 may apply a visually distinct formatting 503 to the text corresponding to the edit 500. As shown in the modified document 540, the visually distinct formatting 503 is an underlining of the text. Further, the document comparison engine 220 may identify that an unedited portion 501 of response template 530 is included in the target document 510 and in response, the document editor 230 may include the predetermined edit 502 corresponding to the unedited portion 501. In particular, the document editor 230 may include the predetermined edit 502 using a visually distinct formatting 505 in the modified document 540. Additionally, the document comparison engine 220 may identify edits of the target document 510 that are not in templates of the employment agreement type. In response, the document editor 230 uses a visually distinct formatting 504 to identify, within the modified document 540, the edits that are absent from templates of the AI system 110 (e.g., templates stored within the database 260).

### Processes for Redlining Documents Using the Artificial Intelligence System

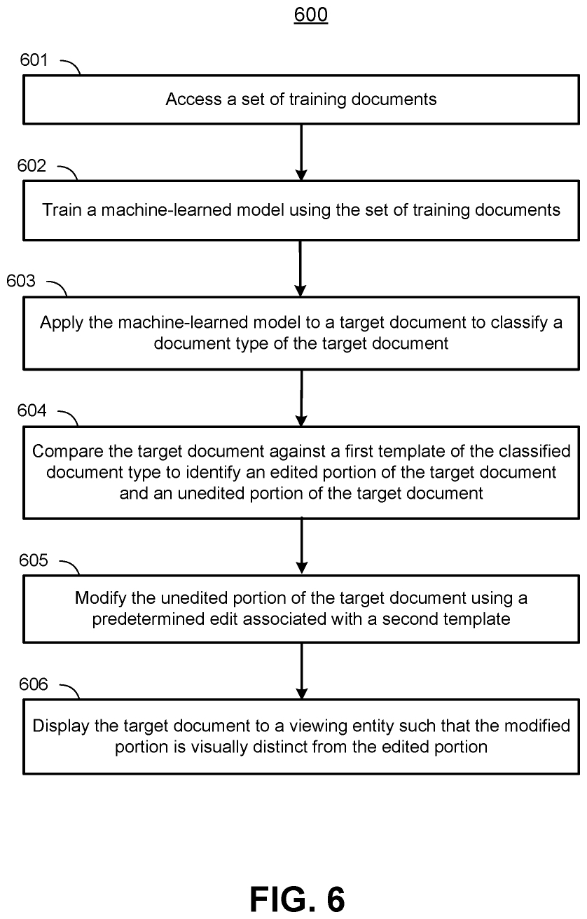

FIG. 6 is a flowchart illustrating a process 600 for redlining a target document, in accordance with one embodiment. The process 600 includes modifying and displaying a target document using visually distinct formatting. In some embodiments, the AI system 110 performs operations of the process 600 in parallel or in different orders, or may perform different steps. For example, the process 600 may include generating a prompt at the client device of the user to select templates with which the comparison 604 is performed.

The AI system 110 accesses 601 a set of training documents. The set of training documents may correspond to document templates of respective document types. Each training document may include one or more sets of edits made by one or more entities. The template database 260 of the AI system 110 may store various document templates, where different document types are represented in the database 260 by the presence one or more document templates of those types (e.g., various non-disclosure agreements, vendor contracts, voting agreements, contracts, etc. that serve as training documents). The one or more entities may be counterparties that have edited the training documents during negotiation. In one example of accessing 601 a set of training documents, the model training engine 240 accesses training documents of various versions of escrow agreements that have been edited and used in negotiations.

The AI system 110 trains 602 a machine-learned model using the set of training documents. The machine-learned model is configured to, when applied to a document from a counterparty entity, classify the document as having a document type of the respective types present among the training documents. In one example of training 602 a machine-learned model, the model training engine 240 uses templates within the template database 260 as training documents to train a classifier model 210. The model training engine 240 can extract feature vectors from the training documents and label the extracted vectors using the document types of the training documents from which they were extracted. The model training engine 240 may then use the labeled vectors to train 602 the machine-learned model.

The AI system 110 applies 603 the machine-learned model to a target document to classify a document type of the target document. For example, the document classifier 200 may apply 603 a classifier model 210 to determine that a target document is an escrow agreement.

The AI system 110 compares 604 the target document against a first template of the classified document type to identifying an edited portion of the target document and an unedited portion of the target document. The edited portion may include a first set of edits and a second set of edits. The first set of edits can be similar to edits made to one or more of the set of training documents and the second set of edits may be distinct from edits made to the set of training documents. In some embodiments, the AI system 110 can compare 604 the target document against the first template by identifying unedited portions of the first template and then comparing the target document to the unedited portions of the first template. After determining which unedited portions match, the AI system 110 can then identify the edited portion of the target document (e.g., as portions of the target document that are not the matching, unedited portions). In some embodiments, the AI system 110 can compare 604 the target document against the first template using a machine-learned model trained to identify differences (e.g., addition, removal, or movement of edited text) between two or more documents or similarities between two or more documents. Accordingly, the AI system 110 may use machine learning to identifying edited or unedited portions of the target document.

The AI system 110 modifies 605 the unedited portion of the target document using a predetermined edit associated with a second template. The modification 605 of the unedited portion may include a replacement of the unedited portion with the predetermined edit, an inclusion of the predetermined edit within the unedited portion of the target document (e.g., between words or groups of words), any suitable modification of the target document to include the predetermined edit, or a combination thereof. In some embodiments, the AI system 110 may modify 605 the unedited portion by determining that the predetermined edit, among various predetermined edits, corresponds to the unedited portion of the target document. The AI system 110 may then replace the unedited portion of the target document with the predetermined edit. In some embodiments, determining that the predetermined edit corresponds to the unedited portion of the target document includes identifying unedited text associated with the second template that matches the unedited portion of the target document. The unedited text may be mapped, by the AI system 110, to the predetermined edit.

The second template may be a response template of the document templates, where the response template includes at least one modification by one or more counterparty entities to the first template. The response template may also include predetermined edits that map to the modifications by counterparty entities to the first template. In some embodiments, the AI system 110 may perform an additional modification to the target document using a predetermined edit associated with the first template (e.g., the predetermined edit is included in the first template). For example, the additional modification may be performed on a different, unedited portion of the target document such that the target document includes predetermined edits associated with both the first and second templates. In some embodiments, the second template used to modify 605 the unedited portion of the target document is the first template. That is, the modification 605 is based on the same template that was used to compare 604 the target document for differences.

In some embodiments, the AI system 110 can modify the target document to include an annotation that was mapped to the predetermined edit associated with the second template. The AI system 110 may identify the annotation as being mapped within the second template to the predetermined edit, where the annotation includes a user comment. For example, an entity commented on a proposed edit with a motivation for why the proposed edit was included. The AI system 110 can annotate the modified portion of the target document with the annotation (e.g., including the previous example's comment regarding the motivation for the edit in the redlined document).

The AI system 110 displays 606 the target document to a viewing entity such that the modified portion is visually distinct from the edited portion. The modified portion may be visually distinct based on one or more of a font color, font type, font size, highlighting, text borders, shading, animated effect, any suitable formatting of text affecting the appearance of the text, or combination thereof. The AI system 110 can display 606 the target document to the viewing entity such that the first set of edits, the second set of edits, and the modified portion of the target document are visually distinct from one another. For example, as shown in FIGS. 4 and 5, edits of the target document that were existing or added by the AI system 110 are visually distinct from one another using different visual effects (e.g., underlining and borders around the text).

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
accessing, by an artificial intelligence system, a set of training documents corresponding to document templates of respective document types, each training document including one or more sets of edits made by one or more entities;
training, by the artificial intelligence system, a machine-learned model using the set of training documents, the machine-learned model configured to, when applied to a document from a counterparty entity, classify the document as having a type of the respective document types;
applying, by the artificial intelligence system, the machine-learned model to a target document to classify a document type of the target document;
comparing, by the artificial intelligence system, the target document against a first template of the classified document type to identify an edited portion of the target document and unedited portion of the target document, wherein the edited portion includes a first set of edits and a second set of edits, the first set of edits similar to edits made to one or more of the set of training documents and the second set of edits distinct from edits made to the set of training documents;
modifying, by the artificial intelligence system, the unedited portion of the target document using a predetermined edit associated with a second template; and
displaying, by the artificial intelligence system, the target document to a viewing entity such that the modified portion is visually distinct from the edited portion.

2. The method of claim 1, wherein the modified portion is visually distinct based on one or more of font color, font type, font size, highlighting, text borders, shading, or animated effect.

3. The method of claim 1, further comprising:
displaying, by the artificial intelligence system, the target document to the viewing entity such that first set of edits, the second set of edits, and the modified portion are visually distinct from one another.

4. The method of claim 1, wherein the second template is a response template of the document templates, the response template including at least one modification by one or more counterparty entities to the first template.

5. The method of claim 4, wherein the unedited portion of the target document is a first unedited portion, further comprising:
modifying a second unedited portion of the target document using a predetermined edit associated with the first template.

6. The method of claim 1, wherein the second template is the first template.

7. The method of claim 1, further comprising:
identifying an annotation mapped to the predetermined edit associated with the second template, wherein the annotation includes a user comment; and
annotating the modified portion with the annotation.

8. The method of claim 1, wherein comparing the target document against the first template of the classified document type to identify the edited portion of the target document and the unedited portion of the target document comprises:
identifying unedited portions of the first template; and
comparing the target document to the unedited portions of the first template to identify the edited portion of the target document.

9. The method of claim 1, wherein modifying the unedited portion of the target document using the predetermined edit associated with the second template comprises:
determining the predetermined edit corresponding to the unedited portion of the target document; and
replacing the unedited portion of the target document with the predetermined edit.

10. The method of claim 9, wherein determining the predetermined edit corresponding to the unedited portion of the target document comprises:
identifying unedited text associated with the second template that matches the unedited portion of the target document, wherein the unedited text is mapped, by the artificial intelligence system, to the predetermined edit.

11. An artificial intelligence system comprising:
one or more processors; and
a non-transitory computer readable storage medium storing executable instructions that, when executed by the one or more processors, cause the one or more processors to perform steps comprising:
accessing, by an artificial intelligence system, a set of training documents corresponding to document templates of respective document types, each training document including one or more sets of edits made by one or more entities;
training, by the artificial intelligence system, a machine-learned model using the set of training documents, the machine-learned model configured to, when applied to a document from a counterparty entity, classify the document as having a type of the respective document types;
applying, by the artificial intelligence system, the machine-learned model to a target document to classify a document type of the target document;
comparing, by the artificial intelligence system, the target document against a first template of the classified document type to identify an edited portion of the target document and unedited portion of the target document, wherein the edited portion includes a first set of edits and a second set of edits, the first set of edits similar to edits made to one or more of the set of training documents and the second set of edits distinct from edits made to the set of training documents;
modifying, by the artificial intelligence system, the unedited portion of the target document using a predetermined edit associated with a second template; and
displaying, by the artificial intelligence system, the target document to a viewing entity such that the modified portion is visually distinct from the edited portion.

12. The artificial intelligence system of claim 11, wherein the modified portion is visually distinct based on one or more of font color, font type, font size, highlighting, text borders, shading, or animated effect.

13. The artificial intelligence system of claim 11, the instructions further comprising instructions that, when executed by the one or more processors, cause the one or more processors to perform steps comprising:
displaying, by the artificial intelligence system, the target document to the viewing entity such that first set of edits, the second set of edits, and the modified portion are visually distinct from one another.

14. The artificial intelligence system of claim 11, wherein the second template is a response template of the document templates, the response template including at least one modification by one or more counterparty entities to the first template.

15. The artificial intelligence system of claim 14, wherein the unedited portion of the target document is a first unedited portion, and the instructions further comprising instructions that, when executed by the one or more processors, cause the one or more processors to perform steps comprising:
modifying a second unedited portion of the target document using a predetermined edit associated with the first template.

16. A non-transitory computer readable storage medium storing executable instructions that, when executed by one or more processors, cause the one or more processors to perform steps comprising:
accessing, by an artificial intelligence system, a set of training documents corresponding to document templates of respective document types, each training document including one or more sets of edits made by one or more entities;
training, by the artificial intelligence system, a machine-learned model using the set of training documents, the machine-learned model configured to, when applied to a document from a counterparty entity, classify the document as having a type of the respective document types;
applying, by the artificial intelligence system, the machine-learned model to a target document to classify a document type of the target document;
comparing, by the artificial intelligence system, the target document against a first template of the classified document type to identify an edited portion of the target document and unedited portion of the target document, wherein the edited portion includes a first set of edits and a second set of edits, the first set of edits similar to edits made to one or more of the set of training documents and the second set of edits distinct from edits made to the set of training documents;
modifying, by the artificial intelligence system, the unedited portion of the target document using a predetermined edit associated with a second template; and
displaying, by the artificial intelligence system, the target document to a viewing entity such that the modified portion is visually distinct from the edited portion.

17. The non-transitory computer readable storage medium of claim 16, wherein the modified portion is visually distinct based on one or more of font color, font type, font size, highlighting, text borders, shading, or animated effect.

18. The non-transitory computer readable storage medium of claim 16, wherein the instructions further comprise instructions that, when executed by one or more processors, cause the one or more processors to perform steps comprising:
displaying, by the artificial intelligence system, the target document to the viewing entity such that first set of edits, the second set of edits, and the modified portion are visually distinct from one another.

19. The non-transitory computer readable storage medium of claim 16, wherein the second template is a response template of the document templates, the response template including at least one modification by one or more counterparty entities to the first template.

20. The non-transitory computer readable storage medium of claim 19, wherein the unedited portion of the target document is a first unedited portion, and wherein the instructions further comprise instructions that, when executed by one or more processors, cause the one or more processors to perform steps comprising:
modifying a second unedited portion of the target document using a predetermined edit associated with the first template.
